(19) United States
(12) Patent Application Publication
(10) Pub. No.: US 2025/0343384 A1
(43) Pub. Date: Nov. 6, 2025

(54) CONNECTOR ASSEMBLY

(71) Applicant: Bellwether Electronic Corp., Taoyuan City (TW)

(72) Inventors: Hsing-Yu LEE, Taoyuan City (TW); Yen-Jang LIAO, Taoyuan City (TW); Ching-Hsiang CHANG, Taoyuan City (TW); Yung-Liang CHI, Taoyuan City (TW)

(21) Appl. No.: 19/178,898

(22) Filed: Apr. 15, 2025

Related U.S. Application Data
(60) Provisional application No. 63/642,106, filed on May 3, 2024.

(30) Foreign Application Priority Data
Jan. 8, 2025 (TW) 114100779

(51) Int. Cl. H01R 25/14

(52) U.S. Cl. CPC H01R 25/142

(57) ABSTRACT

A connector assembly includes a busbar connector, a first cable-end connector, a second cable-end connector, a first cable, and a second cable. The first cable-end connector is electrically connected to the busbar connector. The second cable-end connector is electrically connected to the busbar connector. The first cable is connected between the busbar connector and the first cable-end connector. The second cable is connected between the busbar connector and the second cable-end connector. A length of the first cable is different from a length of the second cable.

### CROSS-REFERENCE TO RELATED APPLICATION

This application claims priority to U.S. Provisional Application Ser. No. 63/642,106 filed May 3, 2024, and Taiwan Application Serial Number 114100779, filed Jan. 8, 2025, the disclosures of which are incorporated herein by reference in their entireties.

### BACKGROUND

### Field of Invention

The present invention relates to a connector assembly, especially a busbar connector assembly.

### Description of Related Art

In general, whether an electrical connection of a cable and a circuit board or between a cable and a busbar, repeated plugging and unplugging is achieved through a connector.

However, as the overall current demand of a system increases, the quantity of conductive terminals on the connector and the size of the connector will also increase accordingly. Different system configurations require different levels of current. Since the specifications of busbar connectors are mostly fixed (i.e., the current rating of specifications is fixed), different current demands lead to an increase in the variety of connectors needed. This in turn results in higher production and inventory costs.

Therefore, how to propose a connector assembly that can solve the aforementioned problems is one of the problems that the industry is currently eager to invest in research and development resources to solve.

### SUMMARY

In view of this, one purpose of the present disclosure is to provide a connector assembly that can solve the aforementioned problems.

In order to achieve the above objective, in accordance with an embodiment of the present disclosure, a connector assembly includes a busbar connector, a first cable-end connector, a second cable-end connector, a first cable, and a second cable. The first cable-end connector is electrically connected to the busbar connector. The second cable-end connector is electrically connected to the busbar connector. The first cable is connected between the busbar connector and the first cable-end connector. The second cable is connected between the busbar connector and the second cable-end connector. A length of the first cable is different from a length of the second cable.

In one or more embodiments of the present disclosure, the busbar connector includes a groove and two power terminal sets. The two power terminal sets are located at two sides of the groove and are configured to be electrically connected to a busbar inserted into the groove.

In one or more embodiments of the present disclosure, the busbar connector further includes a bottom portion, two extending portions, and a wing portion. The two extending portions extend in parallel from the bottom portion and are separated from each other. The two extending portions define the groove. The wing portion is disposed between the bottom portion and the two extending portions. Two opposite sides of the wing portion are flush with two opposite sides of the bottom portion. The wing portion extends beyond the other two opposite sides of the bottom portion.

In one or more embodiments of the present disclosure, each of the two power terminal sets further includes an inner terminal and an outer terminal. The inner terminal includes a plurality of cantilevers. A gap is formed between every two adjacent ones of the cantilevers of the inner terminal. A width of one of the cantilevers of the inner terminal and a width of the gap of the inner terminal are in a ratio of 7:3 or greater. The outer terminal includes a plurality of cantilevers. A gap is formed between every two adjacent ones of the cantilevers of the outer terminal. A width of one of the cantilevers of the outer terminal and a width of the gap of the outer terminal are in a ratio of 7:3 or greater.

In one or more embodiments of the present disclosure, the wing portion includes a lower wing portion and an upper wing portion. A long slot is located between the lower wing portion and the upper wing portion.

In one or more embodiments of the present disclosure, the first cable-end connector includes two busbar terminals. Each of the two busbar terminals includes a tabular structure and a plate structure integrally formed. The plate structure is electrically connected to the two power terminal sets respectively by the first cable.

In one or more embodiments of the present disclosure, the first cable-end connector includes a cable-end housing, an engaging part, and a pull ring. The engaging part is disposed on a first side surface of the cable-end housing. The engaging part seesaws relative to a surface of the first side surface. The pull ring is rotatably disposed on a second side surface adjacent to the first side surface. When the pull ring is rotated to an unlocking state, an end of the pull ring presses against the engaging part to enable the engaging part to seesaw.

In one or more embodiments of the present disclosure, the engaging part further includes a fixing portion, an elastic arm, a pressing portion, and a hook. The fixing portion is disposed on the first side surface. The elastic arm is connected to the fixing portion and extends parallel to the surface of the first side surface. The pressing portion is located at an end of the elastic arm close to the pull ring. The hook is located at the other end of the elastic arm away from the pull ring.

In one or more embodiments of the present disclosure, the engaging part includes a guiding portion. When the pull ring is rotated, the end of the pull ring moves within the guiding portion.

In one or more embodiments of the present disclosure, the pull ring includes a finger portion at the end of the pull ring. When the finger portion presses a triggering surface of the guiding portion, the pressing portion moves toward the surface of the first side surface of the cable-end housing, such that the hook moves away from the surface of the first side surface of the cable-end housing.

In one or more embodiments of the present disclosure, the cable-end housing further includes an accommodating hook on the second side surface. The accommodating hook is configured to be engaged with another end of the pull ring to secure the pull ring.

In one or more embodiments of the present disclosure, the cable-end housing further includes a middle hook on the second side surface. The pull ring includes a ring portion, a shaft portion, and a finger portion. The shaft portion is connected to the ring portion. The finger portion is connected to the shaft portion. The shaft portion is pivotally connected to the middle hook such that the pull ring is rotatable relative to the middle hook.

In one or more embodiments of the present disclosure, the second cable-end connector includes two busbar terminals, a second housing, and a second top cover. The second housing accommodates the two busbar terminals. The two busbar terminals are disposed diagonally in the second housing. The second top cover covers the second housing.

In one or more embodiments of the present disclosure, the second housing includes a first side surface, a second side surface, a third side surface, and an engaging part. The first side surface and the second side surface are disposed oppositely. The third side surface is connected to the first side surface and the second side surface. The engaging part is disposed on the third side surface. The two busbar terminals partially overlap in a direction parallel to the first side surface.

In order to achieve the above objective, in accordance with an embodiment of the present disclosure, a connector assembly includes a busbar connector, a first cable-end connector, a second cable-end connector, a first cable, and a second cable. The busbar connector includes a groove and a power terminal set located at a side of the groove. The power terminal set includes an inner terminal and an outer terminal. The inner terminal further includes a lower contacting portion located at an end of the inner portion and the outer terminal further includes an upper contacting portion located at an end of the outer terminal. The lower contacting portion is separated from the upper contacting portion. The first cable-end connector is electrically connected to the busbar connector. The second cable-end connector is electrically connected to the busbar connector. The first cable is connected between the busbar connector and the first cable-end connector. The second cable is connected between the busbar connector and the second cable-end connector.

In one or more embodiments of the present disclosure, a length of the first cable is different from a length of the second cable.

In one or more embodiments of the present disclosure, the busbar connector further includes a bottom portion, two extending portions, and a wing portion. The two extending portions extend in parallel from the bottom portion and are separated from each other. The two extending portions define the groove. The wing portion is disposed between the bottom portion and the two extending portions. Two opposite sides of the wing portion have a long slot.

In one or more embodiments of the present disclosure, the two opposite sides of the wing portion are flush with two opposite sides of the bottom portion.

In one or more embodiments of the present disclosure, a height of the two extending portions and a width of the groove are in a ratio of 8:1 or greater.

In one or more embodiments of the present disclosure, the inner terminal includes a plurality of cantilevers. A gap is formed between every two adjacent ones of the cantilevers of the inner terminal. A width of one of the cantilevers of the inner terminal is in a ratio of 7:3 or greater with respect to a width of the gap of the inner terminal. The outer terminal includes a plurality of cantilevers. A gap is formed between every two adjacent ones of the cantilevers of the outer terminal. A width of one of the cantilevers of the outer terminal is in a ratio of 7:3 or greater with respect to a width of the gap of the outer terminal.

In summary, in the connector assembly of the present disclosure, since the lower contacting portion of the inner terminal and the upper contacting portion of the outer terminal of the busbar connector are separated from each other, resistance can be reduced when the busbar connector is engaged with the busbar. In the connector assembly of the present disclosure, since the first base portion of the inner terminal, the busbar, and the second base portion of the outer terminal are fixed to each other, and the supporting ribs protrude toward the inner terminal, the supporting ribs can provide a bearing surface for the inner terminal that may move inward when the busbar connector is engaged with the busbar, thereby achieving a stabilizing effect on the structure of the conductive terminals. In the connector assembly of the present disclosure, since the pull ring of the first connector can drive the engaging part to seesaw relative to the surface of the upper housing of the first connector, the user can perform the connector's insertion and removal with less effort. In the connector assembly of the present disclosure, since the two busbar terminals of the second connector are arranged diagonally in the upper housing of the second connector, and the two busbar terminals are partially overlapped in a direction, the size of the second connector can be reduced. In the connector assembly of the present disclosure, since the length of the first cable is different from that of the second cable, the first connector and the second connector are staggered with respect to each other in a top view, so that the first connector and the second connector do not interfere with each other, thereby enabling the user to operate the first connector and the second connector more conveniently. In conclusion, the connector assembly of the present disclosure not only enhances the structural stability of the conductive terminals in the busbar connector, but also improves the convenience for users when performing insertion and removal operations of the connector.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a connector assembly in accordance with an embodiment of the present disclosure;

FIG. 2 is a perspective view of a busbar connector in accordance with an embodiment of the present disclosure;

FIG. 3 is an exploded view of a busbar connector in accordance with an embodiment of the present disclosure;

FIG. 4 is a cross-sectional view of a busbar connector in accordance with an embodiment of the present disclosure;

FIG. 5 is another cross-sectional view of a busbar connector in accordance with an embodiment of the present disclosure;

FIG. 6 is an exploded view of a first connector in accordance with an embodiment of the present disclosure;

FIG. 7 is a top view of a first connector in accordance with an embodiment of the present disclosure;

FIG. 8 is a cross-sectional view of a first connector in a first state in accordance with an embodiment of the present disclosure;

FIG. 9 and FIG. 10 are perspective views respectively showing the first connector in a second state and a third state in accordance with an embodiment of the present disclosure;

FIG. 11 is an exploded view of a second connector in accordance with an embodiment of the present disclosure; and

FIG. 12 is a perspective view of an upper housing of the second connector and the busbar terminals in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a connector assembly 100 of this embodiment and the connection relationship between the components will be described in detail.

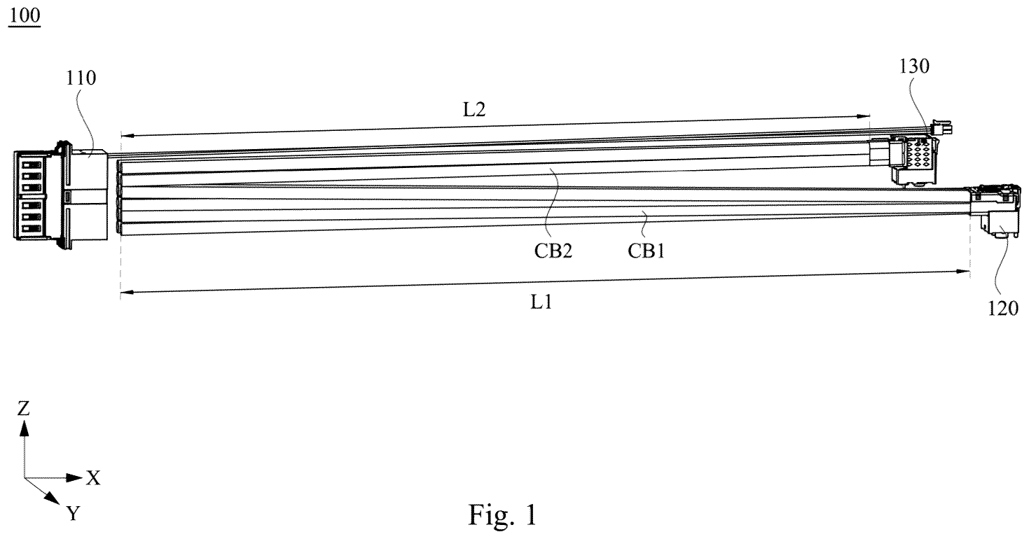

Reference is made to FIG. 1. FIG. 1 is a perspective view of a connector assembly 100 in accordance with an embodiment of the present disclosure. As shown in FIG. 1, in this embodiment, the connector assembly 100 includes a busbar connector 110, a first connector assembly 120, a second connector assembly 130, a first cable CB1, and a second cable CB2. The busbar connector 110 is configured to be mated with a busbar (not shown). The first connector assembly 120 includes a cable-end connector and a board-end connector that are mateable with each other. The cable-end connector is electrically connected to an end of the first cable CB1, and the board-end connector is configured to be mounted on a circuit board (not shown). The second connector assembly 130 also includes a cable-end connector and a board-end connector that are mateable with each other. The cable-end connector is electrically connected to an end of the second cable CB2, and the board-end connector is configured to be mounted on the same or another circuit board. The other end of the first cable CB1 is electrically connected to the busbar connector 110, such that the first connector assembly 120 is electrically connected to the busbar connector 110. The other end of the second cable CB2 is electrically connected to the busbar connector 110, such that the second connector assembly 130 is electrically connected to the busbar connector 110. The second connector assembly 130 is separated from the first connector assembly 120. In some embodiments, the first cable CB1 and the second cable CB2 generally extend along a direction (e.g., X-direction) and so the busbar connector 110 is a straight-exit connector. The first cable CB1 has a length L1, and the second cable CB2 has a length L2. The length L1 of the first cable CB1 is different from the length L2 of the second cable CB2. In some embodiments, the length L1 of the first cable CB1 is greater than the length L2 of the second cable CB2.

As shown in FIG. 1, in some embodiments, the first connector assembly 120 and the second connector assembly 130 are generally arranged along a direction (e.g., Z-direction). In some embodiments, in a top view (i.e., in a view along Z-direction), the first connector assembly 120 and the second connector assembly 130 are staggered with respect to each other. For example, the board-end connector of the first connector assembly 120 is disposed on an upper circuit board, and the board-end connector of the second connector assembly 130 is disposed on a lower circuit board. The upper circuit board and the lower circuit board are offset from each other by a small distance, such that the board-end connector of the second connector assembly 130 disposed on the lower board is not sheltered from the upper circuit board in a top view.

In some embodiments, the busbar connector 110 may be a 2U connector. That is, a width of the busbar connector 110 is twice that of a standard connector (1U connector). A height of the two extending portions 112 in Z-direction and a distance between two outer sides of the two extending portions 112 in Y-direction are in a ratio of 3:1 or greater. A height of the two extending portions 112 in Z-direction and a width of the groove T in Z-direction are in a ratio of 8:1 or greater.

In some embodiments, a current conducted by the first cable CB1 is greater than that conducted by the second cable CB2. For example, the first cable CB1 may conduct approximately 300 amperes of current, and the second cable CB2 may conduct approximately 200 amperes of current. Accordingly, the busbar connector 110 may conduct approximately 500 amperes of current.

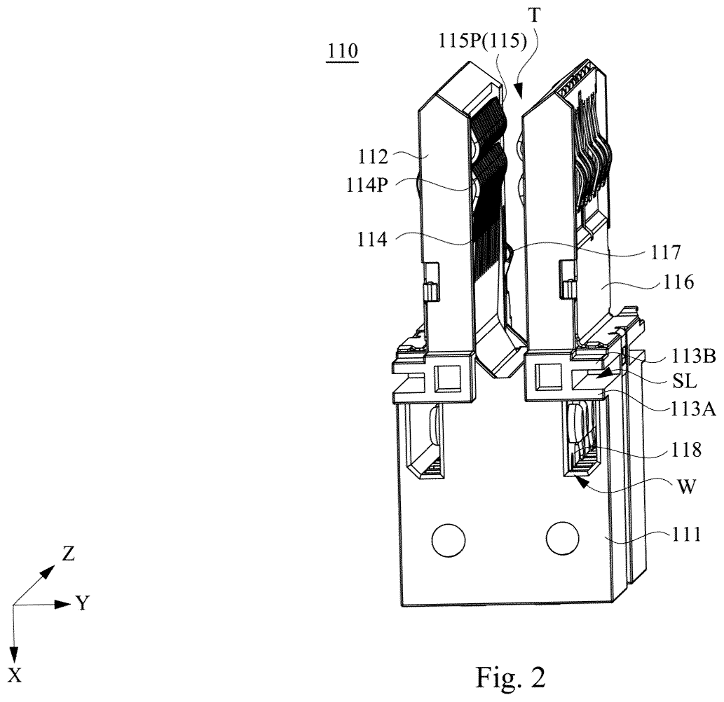

Reference is made to FIG. 2. FIG. 2 is a perspective view of the busbar connector 110 in accordance with an embodiment of the present disclosure. As shown in FIG. 2, in this embodiment, the busbar connector 110 includes a bottom portion 111, two extending portions 112, a wing portion, two power terminal sets, a ground terminal 116, a detecting terminal 117, and a resilient sheet 118. The two power terminal sets are electrically isolated from each other, and each of the two power terminal sets includes an inner terminal 114 and an outer terminal 115. The two extending portions 112 extend from the bottom portion 111. Specifically, the two extending portions 112 extend in parallel from the bottom portion 111. The two extending portions 112 are spaced apart to jointly define a groove T. An installing slot is formed on a back side of the bottom portion 111. The groove T communicates with the installing slot. The groove T is configured to accommodate the busbar (not shown), and the two power terminal sets are respectively located at two sides of the groove T and are configured to be electrically connected to two copper bars of the busbar. Each of the two copper bars provides a different potential. The first cable CB1 and the second cable CB2 respectively include a plurality of cables, which may be grouped into a positive power cable set and a negative power cable set respectively connected to the two power terminal sets to transmit currents of different potentials.

The wing portion is disposed between the bottom portion 111 and the two extending portions 112. Two opposite sides of the wing portion are flush with two opposite sides of the bottom portion 111 and extend beyond the other two opposite sides of the bottom portion 111 in a direction (e.g., Z-direction). In some embodiments, the wing portion includes a lower wing portion 113A and an upper wing portion 113B. A long slot SL is defined between the lower wing portion 113A and the upper wing portion 113B, and the long slot SL is configured to position the busbar connector 110 relative to a chassis (not shown). The inner terminal 114 penetrates into the installing slot of the bottom portion 111 and is exposed within the groove T. The outer terminal 115 also penetrates into the installing slot of the bottom portion 111 and is adjacent to an outer side of the inner terminal 114, i.e., the outer terminal 115 is located between the inner terminal 114 and the corresponding extending portion 112.

Each of the inner terminal 114 and the outer terminal 115 includes a plurality of cantilevers. The cantilevers are bent inwardly to respectively form a lower contacting portion 114P and an upper contacting portion 115P. A plurality of lower contacting portions 114P are arranged in a direction (e.g., Z-direction), and a plurality of upper contacting portions 115P are also arranged in this direction. The lower contacting portions 114P are closer to the wing portion (or the bottom portion 111) than the upper contacting portions 115P. That is, the upper contacting portions 115P are closer to a front end of the groove T relative to the lower contacting portions 114P. The ground terminal 116 is disposed on outer sides of the two extending portions 112. The detecting terminal 117 is located in the groove T. The detecting terminal 117 is configured to detect whether the busbar (not shown) is inserted into the groove T. The resilient sheet 118 is located in the bottom portion 111. The busbar connector 110 further includes an observing window W. The observing window W runs through the bottom portion 111. A portion of the resilient sheet 118 is exposed within the observing window W.

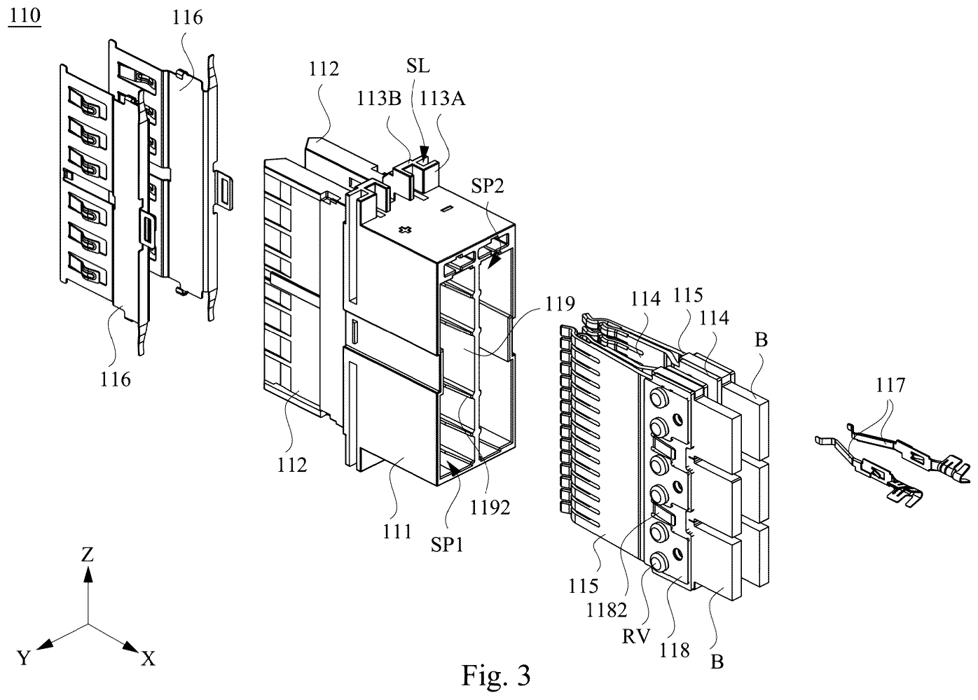

Reference is made to FIG. 3. FIG. 3 is an exploded view of the busbar connector 110 in accordance with an embodiment of the present disclosure. As shown in FIG. 3, in this embodiment, the busbar connector 110 further includes a busbar B, a rivet RV, and a partitioning plate 119. The busbar B is connected to the inner terminal 114 and the outer terminal 115 (e.g., located between the inner terminal 114 and the outer terminal 115). The resilient sheet 118 is fixed to the outer terminal 115. Specifically, the outer terminal 115 is located between the resilient sheet 118 and the inner terminal 114, and is also located between the resilient sheet 118 and the busbar B. The resilient sheet 118 further includes an abutting portion 1182. The abutting portion 1182 extends outwardly from the resilient sheet 118. In some embodiments, the abutting portion 1182 extends from the resilient sheet 118 at an acute angle. The inner terminal 114, the busbar B, the outer terminal 115, and the resilient sheet 118 are fixed to each other by the rivet RV. The busbar connector 110 further includes the partitioning plate 119. The partitioning plate 119 is disposed in the installing slot of the bottom portion 111. Specifically, the installing slot of the bottom portion 111 includes a first accommodating space SP1 and a second accommodating space SP2. The first accommodating space SP1 and the second accommodating space SP2 are separated by the partitioning plate 119. Each of the first accommodating space SP1 and the second accommodating space SP2 is configured to accommodate the inner terminal 114, the outer terminal 115, the resilient sheet 118, and the busbar B. The busbar connector 110 further includes a supporting rib 1192. The supporting rib 1192 protrudes from the partitioning plate 119 toward the inner terminal 114.

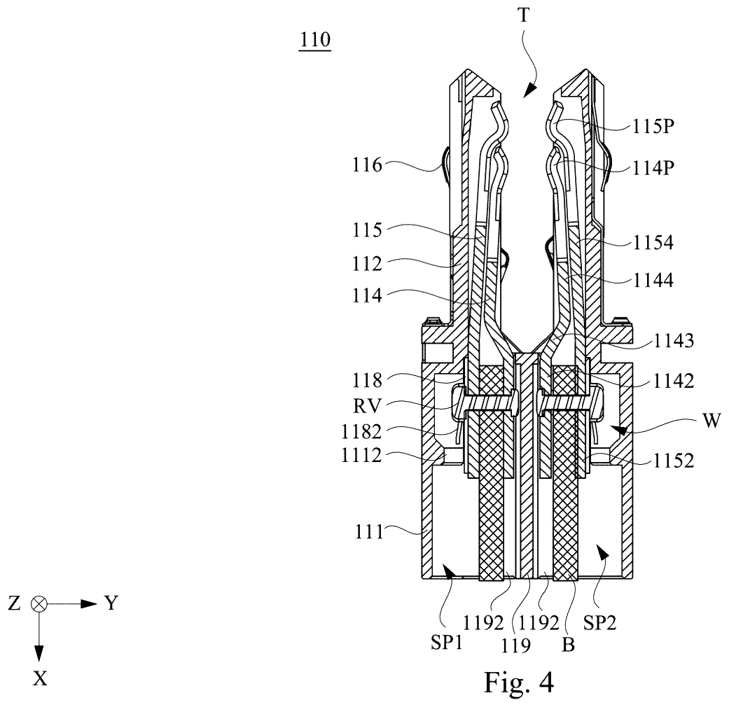

Reference is made to FIG. 4. FIG. 4 is a cross-sectional view of the busbar connector 110 in accordance with an embodiment of the present disclosure. As shown in FIG. 4, in this embodiment, the inner terminal 114 further includes a first base portion 1142, a bending portion 1143, and a first inclined portion (cantilever) 1144. The first base portion 1142 is located in the bottom portion 111, and the first base portion 1142 is located between the busbar B and the partitioning plate 119. The bending portion 1143 is connected to the first base portion 1142. The first inclined portion 1144 is connected to the bending portion 1143. The lower contacting portion 114P is located on the first inclined portion 1144 and is located at an end of the inner terminal 114. The outer terminal 115 further includes a second base portion 1152 and a second inclined portion (cantilever) 1154. The second base portion 1152 is located in the bottom portion 111, and the second base potion 1152 is located between the resilient sheet 118 and the busbar B. The second inclined portion 1154 is connected to the second base portion 1152. The upper contacting portion 115P is located on the second inclined portion 1154 and is located at an end of the outer terminal 115. When the busbar has not yet been inserted into the groove T and is not in contact with the lower contacting portion 114P and the upper contacting portion 115P, the first inclined portion 1144 and the second inclined portion 1154 are spaced apart from each other without contact. The lower contacting portions 114P and the upper contacting portions 115P are arranged in two rows separated along a direction (e.g., X-direction).

Reference is made again to FIG. 4. As shown in FIG. 4, in this embodiment, the installing slot of the bottom portion 111 further includes a blocking portion 1112. The blocking portion 1112 protrudes from an inner surface of the bottom portion 111 toward the outer terminal 115. The abutting portion 1182 and the blocking portion 1112 are partially overlapped in a direction (e.g., X-direction). The blocking portion 1112 and the abutting portion 1182 are exposed within the observing window W. In a usage scenario, when the inner terminal 114, the busbar B, the outer terminal 115, and the resilient sheet 118, which are fixed together by the rivet RV, are installed from the groove T into the installing slot of the bottom portion 111, the abutting portion 1182 of the resilient sheet 118 will abut against the blocking portion 1112 of the bottom portion 111. This prevents the inner terminal 114, the busbar B, the outer terminal 115, and the resilient sheet 118 from falling out of the first accommodating space SP1 and the second accommodating space SP2. In some embodiments, both the first accommodating space SP1 and the second accommodating space SP2 communicate with the groove T.

Reference is made again to FIG. 4. As shown in FIG. 4, in this embodiment, the first base portion 1142 and the second base portion 1152 extend in parallel, and the first inclined portion 1144 and the second inclined portion 1154 also extend in parallel. The first base portion 1142 and the second base portion 1152 clamp the busbar B. In some embodiments, a distance between the first base portion 1142 and the second base portion 1152 is greater than a distance between the first inclined portion 1144 and the second inclined portion 1154.

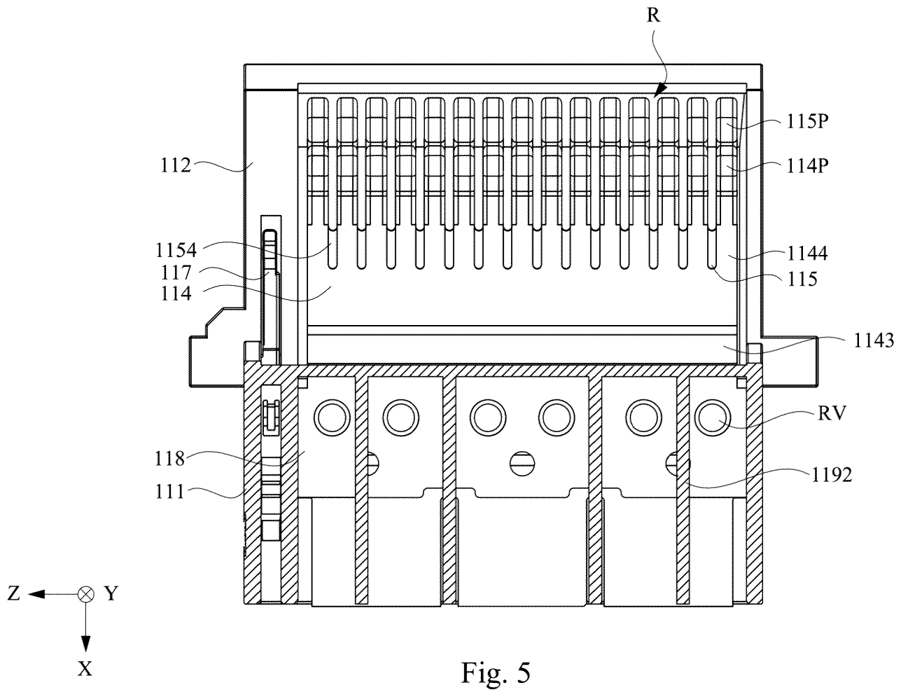

Reference is made to FIG. 5. FIG. 5 is a cross-sectional view of the busbar connector 110 in accordance with an embodiment of the present disclosure. As shown in FIG. 5, in this embodiment, the inner terminal 114 includes a plurality of first inclined portions 1144, and the outer terminal 115 includes a plurality of second inclined portions 1154. A gap R is formed between every two adjacent first inclined portions 1144, and a gap R is also formed between every two adjacent second inclined portions 1154. In some embodiments, a width of the gap R in Z-direction is less than a width of the first inclined portions 1144 in Z-direction and also less than a width of the second inclined portions 1154 in Z-direction. This allows a coverage area of the inner terminal 114 and the outer terminal 115 to be increased. For example, the coverage area of the inner terminal 114 and the outer terminal 115 may reach approximately 70% or more of the occupied space. In other words, a ratio of the width of the cantilevers to the width of the gap R is 7:3 or greater. The lower contacting portions 114P and the upper contacting portions 115P are aligned in a direction (e.g., X-direction). The detecting terminal 117 is separated from the inner terminal 114, and a portion of the detecting terminal 117 is located in the bottom portion 111. In some embodiments, the busbar connector 110 includes a plurality of supporting ribs 1192.

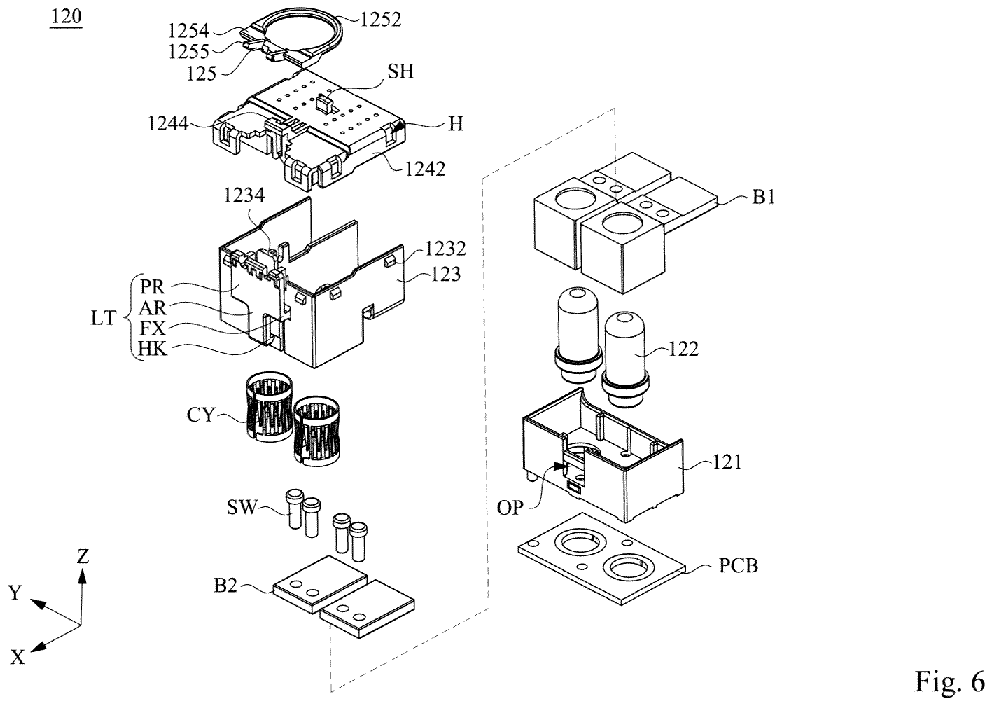

Reference is made to FIG. 6. FIG. 6 is an exploded view of the first connector assembly 120 in accordance with an embodiment of the present disclosure. As shown in FIG. 6, in this embodiment, the first connector assembly 120 includes a cable-end connector and a board-end connector. The board-end connector is configured to be mounted on a circuit board PCB, and the board-end connector includes a first lower housing 121 and a first conductive terminal 122. The first lower housing 121 is disposed on the circuit board PCB. The first lower housing 121 has a bottom surface and four sidewalls, enclosing a mating space, in which one of the four sidewalls has an opening OP. Four edges of the bottom surface are respectively connected to the four sidewalls. A height of the sidewall opposite to the opening OP is lower than a height of the other three sidewalls. The first conductive terminal 122 passes through the bottom surface of the first lower housing 121. An end of the first conductive terminal 122 is electrically connected to the circuit board PCB and the other end of the first conductive terminal 122 is exposed in the mating space of the first lower housing 121. The cable-end connector is configured to be connected to the first cable CB1. The cable-end connector includes a busbar terminal B1, a first upper housing 123, a first top cover 124, and a pull ring 125.

The first upper housing 123 and the first top cover 124 engage with each other to form a cable-end housing configured to accommodate the busbar terminal B1. The busbar terminal B1 includes a tabular structure and a plate structure integrally formed. The tabular structure has a mating slot. The mating slot is a recessed slot extending along Z-direction and forms an opening at an end (or both ends) of the tabular structure. The plate structure extends from one side of the tabular structure in X-direction and is perpendicular to a central axis of the mating slot. The plate structures of two busbar terminals B1 are respectively electrically connected to the positive power cable set and the negative power cable set of the first cable CB1. The cable-end connector may further include a busbar terminal B2. The busbar terminal B2 is also a plate structure. The plate structure is fixed to the busbar terminal B1 by a locking part SW to increase the conductive cross-sectional area. A crown spring CY may be sleeved in the mating slot of the busbar terminal B1 to increase the contact area between terminals when mating with the board-end connector.

Reference is made again to FIG. 6. As shown in FIG. 6, in this embodiment, the first upper housing 123 includes a bump 1232, a bracket 1234, and an engaging part LT. The bump 1232 is disposed on an outer surface of the first upper housing 123. The bracket 1234 is separated from the bump 1232. The engaging part LT is disposed on a surface of a side surface of the cable-end housing (i.e., the first upper housing 123), and the pull ring 125 is rotatably disposed on the adjacent other side surface. Two ends of the engaging part LT seesaw relative to a surface of the first upper housing 123. Specifically, the engaging part LT includes a fixing portion FX, an elastic arm AR, a pressing portion PR, and a hook HK. The fixing portion FX is disposed on the surface of the first upper housing 123. The elastic arm AR is connected to the fixing portion FX and extends parallel to the surface of the first upper housing 123. The pressing portion PR is located at an end of the elastic arm AR close to the pull ring 125, and a width of the pressing portion PR is greater than a width of the elastic arm AR in Y-direction. The hook HK is located at an end of the elastic arm AR away from the pull ring 125. In some embodiments, a side of the first upper housing 123 further includes a recessed region corresponding to the hook HK, and the recessed region is more recessed away from the hook HK with respect to the surface of the side of the first upper housing 123. The first top cover 124 includes a middle hook 1244 and an accommodating hook SH and has a hole H. The middle hook 1244 is engaged with the bracket 1234. The hole H is engaged with the bump 1232. The pull ring 125 includes a ring portion 1252, a shaft portion 1254, and a finger portion 1255. The shaft portion 1254 is connected to the ring portion 1252. The finger portion 1255 is connected to the shaft portion 1254. The shaft portion 1254 is pivotally connected to the middle hook 1244 such that the pull ring 125 is rotatable relative to the middle hook 1244.

When the cable-end connector and the board-end connector are mated, the engaging part LT is engaged with the opening OP for engaging the first upper housing 123 with the first lower housing 121. At this time, the first conductive terminal 122 is inserted into the mating slot of the busbar terminal B1 and is electrically connected to the busbar terminal B1 by the crown spring CY.

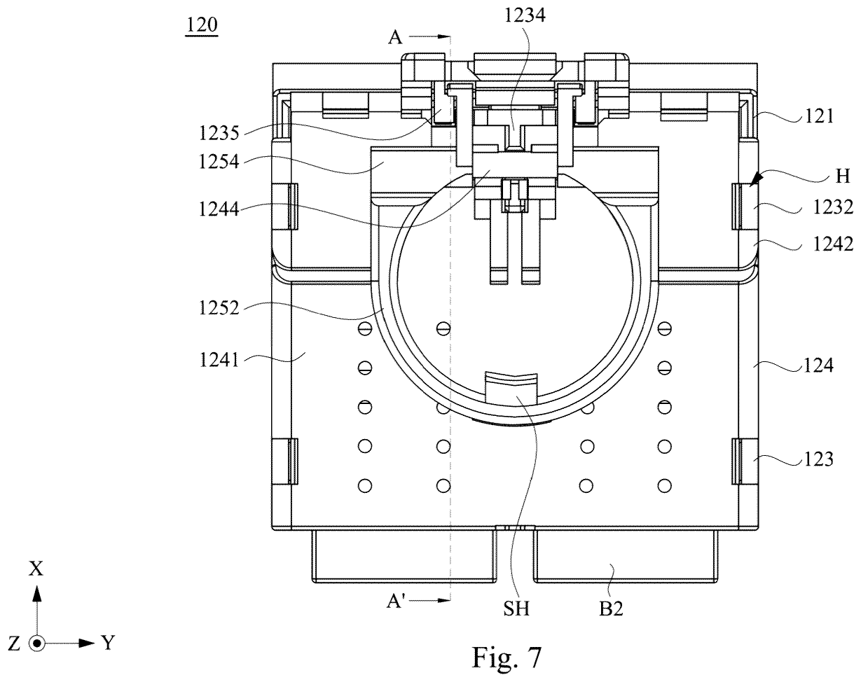

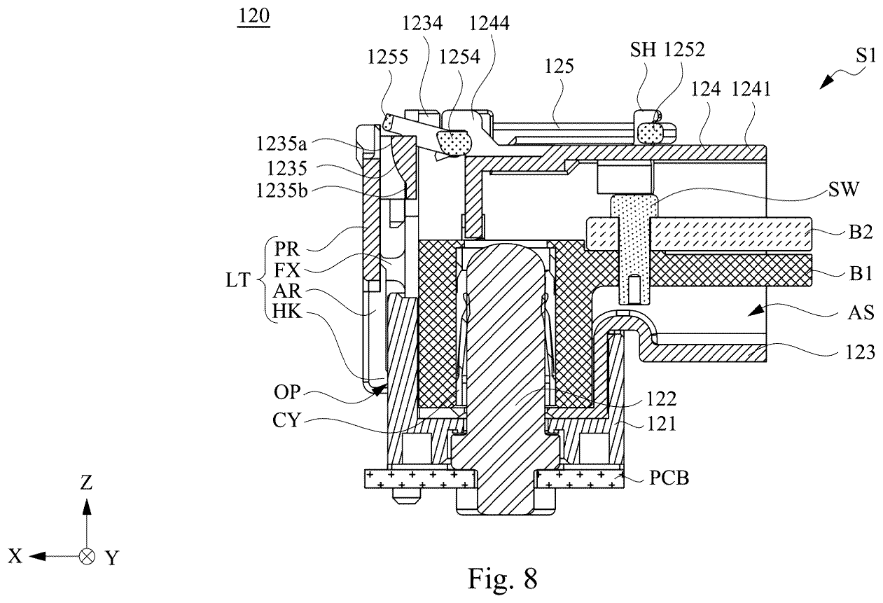

Reference is made to FIG. 7. FIG. 7 is a top view of the first connector assembly 120 in accordance with an embodiment of the present disclosure. As shown in FIG. 7, in this embodiment, the first top cover 124 further includes a cover main body 1241 and a plurality of side plates 1242. Specifically, the plurality of side plates 1242 are connected to the cover main body 1241. A plurality of holes H of the side plates 1242 are engaged with a plurality of bumps 1232 of the first upper housing 123. The engaging part LT further includes a guiding portion 1235. The guiding portion 1235 is located on a side of the engaging part LT close to the pull ring 125, i.e., on the pressing portion PR. The guiding portion 1235 is configured to guide the movement of the finger portion 1255 of the pull ring 125 and abut thereagainst. Reference is made to FIG. 8. The guiding portion 1235 has a curved surface 1235a and a triggering surface 1235b connected to the curved surface 1235a. The triggering surface 1235b may be a flat surface. The shaft portion 1254 of the pull ring 125 is pivotally connected to the middle hook 1244, and the accommodating hook SH is engaged with the ring portion 1252 of the pull ring 125 to secure the pull ring 125, thereby preventing the pull ring 125 from rotating. As shown in FIG. 6 and FIG. 7, in some embodiments, the bracket 1234 has a notch, and the middle hook 1244 is accommodated in the notch of the bracket 1234.

As shown in FIG. 6 and FIG. 7, in some embodiments, the plate structure of the busbar terminal B2 and the plate structure of the busbar terminal B1 are fixed to each other. The plate structure of the busbar terminal B2 and the plate structure of the busbar terminal B1 are respectively connected to a cable set (not shown). Specifically, the cable set may include a first cable set and a second cable set, in which the first cable set is connected to a side of the plate structure of the busbar terminal B1 by ultrasonic welding, whereas the second cable set is connected to a side of the plate structure of the busbar terminal B2 by ultrasonic welding as well. The opposite sides of the plate structure of the busbar terminal B2 and the plate structure of the busbar terminal B1 are attached with each other using the locking part SW by riveting.

Reference is made to FIG. 8. FIG. 8 is a cross-sectional view of the first connector assembly 120 in a first state (mating state) S1 in accordance with an embodiment of the present disclosure. It should be noted that FIG. 8 to FIG. 10 are cross-sectional views of the first connector assembly 120 based on a section A-A′ shown in FIG. 7. As shown in FIG. 8, in this embodiment, the first upper housing 123 and the first top cover 124 jointly define an accommodating space AS. The accommodating space AS accommodates the busbar terminal B1 and the busbar terminal B2. At this time, a portion of the first conductive terminal 122 is inserted into the mating slot of the busbar terminal B1. When the first connector assembly 120 is in the first state S1, the pull ring 125 lies horizontally along the cover main body 1241 of the first top cover 124, and the accommodating hook SH is engaged with the ring portion 1252 of the pull ring 125. The engaging part LT extends parallel to a surface of the first upper housing 123, and the hook HK is engaged with the opening OP, such that the cable-end connector and the board-end connector of the first connector assembly 120 are stably mated. At this time, the finger portion 1255 may not contact the guiding portion 1235.

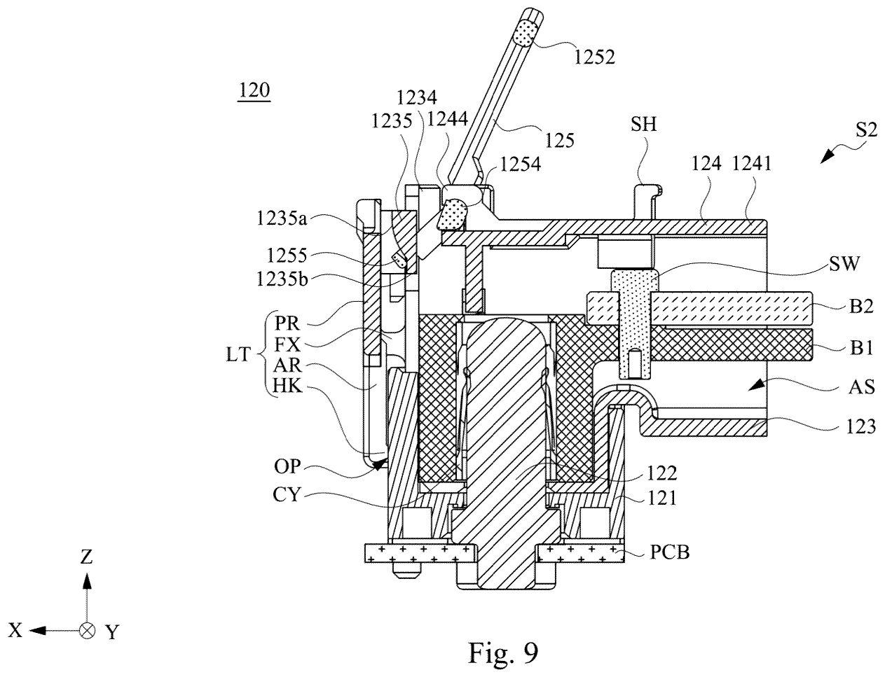

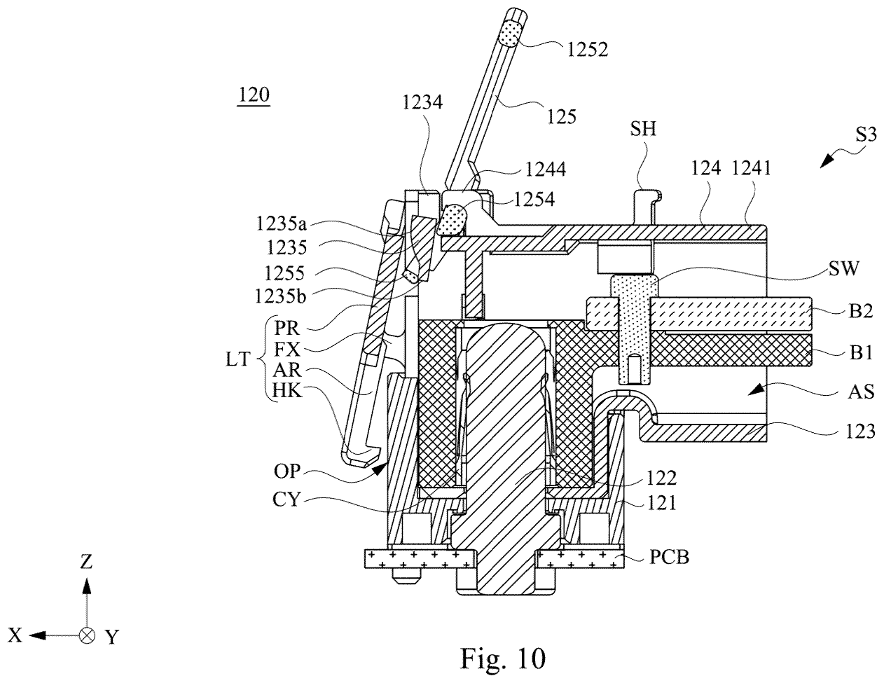

Reference is made to FIG. 9 and FIG. 10. FIG. 9 and FIG. 10 are perspective views of the first connector assembly 120 in a second state (rotating state) S2 and a third state (unlocking state) S3 respectively in accordance with an embodiment of the present disclosure. As shown in FIG. 9, in this embodiment, when the first connector assembly 120 is in the second state S2, the ring portion 1252 of the pull ring 125 is disengaged from the accommodating hook SH and rotates away from the first top cover 124 relative to the shaft portion 1254. A user may put a finger into the ring portion 1252 and pull it upward, thereby causing the pull ring 125 to rotate. At the same time, the finger portion 1255 moves along the curved surface 1235a of the guiding portion 1235. More specifically, when the first connector assembly 120 alters from the first state S1 to the second state S2, the finger portion 1255 enters a guiding groove of the guiding portion 1235. In some embodiments, the finger portion 1255 moves along the curved surface 1235a of the guiding portion 1235 and reaches the triggering surface 1235b. When the finger portion 1255 reaches the triggering surface 1235b, an angle of the ring portion 1252 and the cover main body 1241 is equal to or larger than 15 degrees or a distance of a farthest end of the ring portion 1252 and the cover main body 1241 is equal to or larger than 15 mm.

Next, reference is made to FIG. 10. As shown in FIG. 10, the ring portion 1252 rotates further away from the first top cover 124, thereby triggering the movement of the engaging part LT. Specifically, when the first connector assembly 120 alters from the second state S2 to the third state S3, the finger portion 1255 interferes with the guiding portion 1235, and an end of the engaging part LT close to the pull ring 125 moves toward the surface of the first upper housing 123 and an end of the engaging part LT away from the pull ring 125 moves away from the surface of the first upper housing 123 when the finger portion 1255 presses the triggering surface 1235b of the guiding portion 1235, thereby causing the hook HK to disengage from the opening OP. In this case, the user may pull the pull ring 125 upward to remove the first upper housing 123 from the first lower housing 121, thereby separating the cable-end connector from the board-end connector.

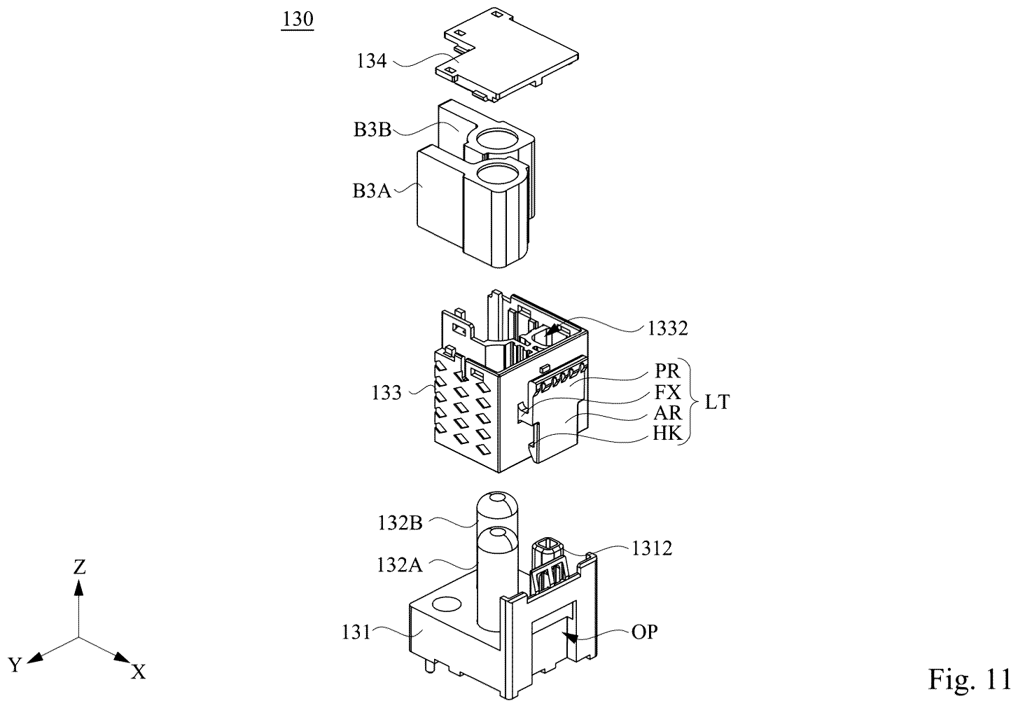

Reference is made to FIG. 11. FIG. 11 is an exploded view of the second connector assembly 130 in accordance with an embodiment of the present disclosure. As shown in FIG. 11, in this embodiment, the second connector assembly 130 includes a cable-end connector and a board-end connector. The board-end connector includes a second lower housing 131, a second conductive terminal 132A, and a second conductive terminal 132B. The second lower housing 131 includes a bottom surface and a sidewall. The sidewall extends upward from a side of the bottom surface and includes an opening OP. The second lower housing 131 further includes a positioning post 1312. The positioning post 1312 extends upward from a region of the bottom surface close to the sidewall. The second conductive terminal 132A and the second conductive terminal 132B are disposed diagonally in the second lower housing 131. An end of each of the second conductive terminal 132A and the second conductive terminal 132B is located below the bottom surface and configured to be electrically connected to a circuit board. The other end of the second conductive terminal 132A and the second conductive terminal 132B is located above the bottom surface and extends parallel to the positioning post 1312.

The cable-end connector includes a second upper housing 133, a busbar terminal B3A, a busbar terminal B3B, and a second top cover 134. Both the busbar terminal B3A and the busbar terminal B3B include a tabular structure and a plate structure integrally formed. The plate structures of the busbar terminal B3A and the busbar terminal B3B are electrically connected to a positive power cable set and a negative power cable set of the second cable CB2, respectively. Each of the tabular structures has a mating slot extending in Z-direction. The plate structure extends from a side of the tabular structure and is parallel to a central axis of the mating slot. The mating slot of the busbar terminal B3A is configured to accommodate the second conductive terminal 132A, and the mating slot of the busbar terminal B3B is configured to accommodate the second conductive terminal 132B. The second upper housing 133 and the second lower housing 131 are engaged with each other. The second upper housing 133 includes an engaging part LT. The engaging part LT includes a fixing portion FX, an elastic arm AR, a pressing portion PR, and a hook HK. The hook HK is configured to be engaged with the opening OP. The second upper housing 133 further has a positioning channel 1332. The positioning channel 1332 is configured to accommodate the positioning post 1312. The second upper housing 133 accommodates the busbar terminal B3A and the busbar terminal B3B, and the second top cover 134 covers the second upper housing 133, thereby securing the busbar terminal B3A and the busbar terminal B3B in the second upper housing 133.

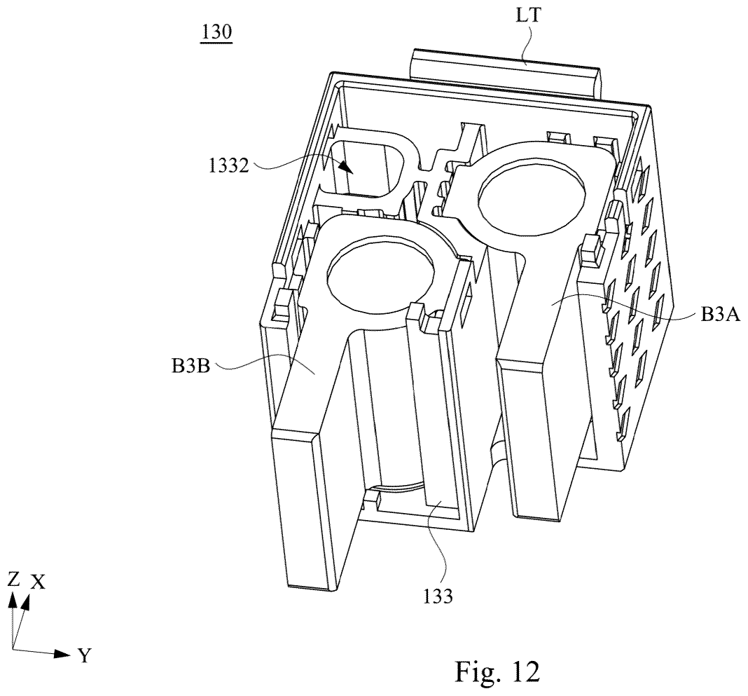

Reference is made to FIG. 12. FIG. 12 is a perspective view of the second upper housing 133, the busbar terminal B3A, and the busbar terminal B3B in accordance with an embodiment of the present disclosure. As shown in FIG. 12, in this embodiment, the positioning channel 1332 is separated from both the busbar terminal B3A and the busbar terminal B3B that are electrically isolated with each other. The busbar terminal B3A and the busbar terminal B3B respectively have a bump on opposite side surfaces. When the busbar terminal B3A and the busbar terminal B3B are arranged diagonally in the second upper housing 133, the bumps allow the terminals to be positioned precisely. The second upper housing 133 includes three side surfaces connected with each other, comprising a first side surface and a second side surface that oppose each other, and a third side surface connected to the first side surface and the second side surface. An opening is formed opposite to the third side surface, which serves as a cable exit. The plate structures of the busbar terminal B3A and the busbar terminal B3B are located at the cable exit and are connected to the second cable CB2. The engaging part LT is located on the third side surface. The busbar terminal B3A and the busbar terminal B3B partially overlap in a direction parallel to the first side surface and the second side surfaces (i.e., Z-direction). This ensures that the volume of the second connector assembly 130 can be reduced, thereby enhancing spatial efficiency.

From the above detailed description of the specific embodiments of the present disclosure, it can be clearly seen that in the connector assembly of the present disclosure, since the lower contacting portion of the inner terminal and the upper contacting portion of the outer terminal of the busbar connector are separated from each other, resistance can be reduced when the busbar connector is engaged with the busbar. In the connector assembly of the present disclosure, since the first base portion of the inner terminal, the busbar, and the second base portion of the outer terminal are fixed to each other, and the supporting ribs protrude toward the inner terminal, the supporting ribs can provide a bearing surface for the inner terminal that may move inward when the busbar connector is engaged with the busbar, thereby achieving a stabilizing effect on the structure of the conductive terminals. In the connector assembly of the present disclosure, since the pull ring of the first connector can drive the engaging part to seesaw relative to the surface of the upper housing of the first connector, the user can perform the connector's insertion and removal with less effort. In the connector assembly of the present disclosure, since the two busbar terminals of the second connector are arranged diagonally in the upper housing of the second connector, and the two busbar terminals are partially overlapped in a direction, the size of the second connector can be reduced. In the connector assembly of the present disclosure, since the length of the first cable is different from that of the second cable, the first connector and the second connector are staggered with respect to each other in a top view, so that the first connector and the second connector do not interfere with each other, thereby enabling the user to operate the first connector and the second connector more conveniently. In conclusion, the connector assembly of the present disclosure not only enhances the structural stability of the conductive terminals in the busbar connector, but also improves the convenience for users when performing insertion and removal operations of the connector.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector assembly, comprising:
a busbar connector;
a first cable-end connector electrically connected to the busbar connector;
a second cable-end connector electrically connected to the busbar connector;
a first cable connected between the busbar connector and the first cable-end connector; and
a second cable connected between the busbar connector and the second cable-end connector,
wherein a length of the first cable is different from a length of the second cable.

2. The connector assembly of claim 1, wherein the busbar connector comprises a groove and two power terminal sets, the two power terminal sets being located at two sides of the groove and configured to be electrically connected to a busbar inserted into the groove.

3. The connector assembly of claim 2, wherein the busbar connector further comprises:
a bottom portion;
two extending portions extending in parallel from the bottom portion and separated from each other, and the two extending portions defining the groove; and
a wing portion disposed between the bottom portion and the two extending portions, wherein two opposite sides of the wing portion are flush with two opposite sides of the bottom portion, and the wing portion extends beyond the other two opposite sides of the bottom portion.

4. The connector assembly of claim 3, wherein each of the two power terminal sets further comprises:
an inner terminal comprising a plurality of cantilevers, wherein a gap is formed between every two adjacent ones of the cantilevers of the inner terminal, and wherein a width of one of the cantilevers of the inner terminal is in a ratio of 7:3 or greater with respect to a width of the gap of the inner terminal; and
an outer terminal comprising a plurality of cantilevers, wherein a gap is formed between every two adjacent ones of the cantilevers of the outer terminal, and wherein a width of one of the cantilevers of the outer terminal is in a ratio of 7:3 or greater with respect to a width of the gap of the outer terminal.

5. The connector assembly of claim 3, wherein the wing portion comprises a lower wing portion and an upper wing portion, and a long slot is located between the lower wing portion and the upper wing portion.

6. The connector assembly of claim 2, wherein the first cable-end connector comprises two busbar terminals, each of the two busbar terminals comprises a tabular structure and a plate structure integrally formed, and the plate structure is electrically connected to the two power terminal sets respectively by the first cable.

7. The connector assembly of claim 1, wherein the first cable-end connector comprises:
a cable-end housing;
an engaging part disposed on a first side surface of the cable-end housing, the engaging part seesawing relative to a surface of the first side surface; and
a pull ring rotatably disposed on a second side surface adjacent to the first side surface,
wherein an end of the pull ring presses against the engaging part to enable the engaging part to seesaw when the pull ring is rotated to an unlocking state.

8. The connector assembly of claim 7, wherein the engaging part further comprises:
a fixing portion disposed on the first side surface;
an elastic arm connected to the fixing portion and extending parallel to the surface of the first side surface;
a pressing portion located at an end of the elastic arm close to the pull ring; and
a hook located at the other end of the elastic arm away from the pull ring.

9. The connector assembly of claim 8, wherein the engaging part comprises a guiding portion, and the end of the pull ring moves within the guiding portion when the pull ring is rotated.

10. The connector assembly of claim 9, wherein the pull ring comprises a finger portion at the end of the pull ring, and the pressing portion moves toward the surface of the first side surface of the cable-end housing when the finger portion presses a triggering surface of the guiding portion, such that the hook moves away from the surface of the first side surface of the cable-end housing.

11. The connector assembly of claim 7, wherein the cable-end housing further comprises an accommodating hook on the second side surface, and the accommodating hook is configured to be engaged with another end of the pull ring to secure the pull ring.

12. The connector assembly of claim 7, wherein the cable-end housing further comprises a middle hook on the second side surface, and the pull ring comprises a ring portion, a shaft portion, and a finger portion, and wherein the shaft portion is connected to the ring portion, the finger portion is connected to the shaft portion, and the shaft portion is pivotally connected to the middle hook such that the pull ring is rotatable relative to the middle hook.

13. The connector assembly of claim 1, wherein the second cable-end connector comprises:
two busbar terminals;
a second housing accommodating the two busbar terminals, wherein the two busbar terminals are disposed diagonally in the second housing; and
a second top cover covering the second housing.

14. The connector assembly of claim 13, wherein the second housing comprises a first side surface, a second side surface, a third side surface, and an engaging part, wherein the first side surface and the second side surface are disposed oppositely, the third side surface is connected to the first side surface and the second side surface, and the engaging part is disposed on the third side surface, and wherein the two busbar terminals partially overlap in a direction parallel to the first side surface.

15. A connector assembly, comprising:
a busbar connector comprising a groove and a power terminal set located at a side of the groove, the power terminal set comprising an inner terminal and an outer terminal, wherein the inner terminal further comprises a lower contacting portion located at an end of the inner terminal and the outer terminal further comprises an upper contacting portion located at an end of the outer terminal, and wherein the lower contacting portion is separated from the upper contacting portion;
a first cable-end connector electrically connected to the busbar connector;
a second cable-end connector electrically connected to the busbar connector;
a first cable connected between the busbar connector and the first cable-end connector; and
a second cable connected between the busbar connector and the second cable-end connector.

16. The connector assembly of claim 15, wherein a length of the first cable is different from a length of the second cable.

17. The connector assembly of claim 15, wherein the busbar connector further comprises:
a bottom portion;
two extending portions extending in parallel from the bottom portion and separated from each other, and the two extending portions defining the groove; and
a wing portion disposed between the bottom portion and the two extending portions, wherein two opposite sides of the wing portion have a long slot.

18. The connector assembly of claim 17, wherein the two opposite sides of the wing portion are flush with two opposite sides of the bottom portion.

19. The connector assembly of claim 17, wherein a height of the two extending portions and a width of the groove are in a ratio of 8:1 or greater.

20. The connector assembly of claim 15, wherein the inner terminal comprises a plurality of cantilevers and a gap is formed between every two adjacent ones of the cantilevers of the inner terminal, wherein a width of one of the cantilevers of the inner terminal is in a ratio of 7:3 or greater with respect to a width of the gap of the inner terminal, wherein the outer terminal comprises a plurality of cantilevers and a gap is formed between every two adjacent ones of the cantilevers of the outer terminal, and wherein a width of one of the cantilevers of the outer terminal is in a ratio of 7:3 or greater with respect to a width of the gap of the outer terminal.
